(19) United States
(12) Patent Application Publication
(10) Pub. No.: US 2016/0322764 A1
(43) Pub. Date: Nov. 3, 2016

(54) Electrical Center With A Bus Bar Retention System

(71) Applicant: Delphi Technologies, Inc., Troy, MI (US)

(72) Inventors: Michal Miroslaw Kowalewski, Krakow (PL); Konrad Tadeusz Kloch, Tarnow (PL)

(21) Appl. No.: 15/083,617

(22) Filed: Mar. 29, 2016

(30) Foreign Application Priority Data
Apr. 30, 2015 (EP) 15165934.9

(51) Int. Cl. H01R 25/14; H01R 9/16; H01R 13/426

(52) U.S. Cl. CPC H01R 25/145; H01R 13/426; H01R 9/16

(57) ABSTRACT

The present invention refers to a retention system for retaining a bus bar, and in particular for retaining a bus bar to an electrical center of a vehicle. The retention system may include a clip, which in turn includes an arm and a hook provided on the arm. The retention system may also include a bus bar which is arranged in a retention groove of the hook.

### CROSS-REFERENCE TO RELATED APPLICATION

This application claims the benefit under 35 U.S.C. §119(a) of Patent Application No. 15165934.9 filed in the European Patent Office (EPO) on Apr. 30, 2015, the entire disclosure of which is hereby incorporated by reference.

### TECHNICAL FIELD OF THE INVENTION

The invention relates to a retention system for retaining a bus bar, and in particular to a retention system for retaining a bus bar to an electrical center of a vehicle.

### BACKGROUND OF THE INVENTION

Automotive electrical distribution centers, or electrical centers of vehicles, generally provide electrical connection of electrical elements such as relays, fuses or the like. Electrical centers may also provide for electrical bussing, for example in a single block, and require a distribution of a common voltage, which is typically supplied by a vehicle battery. It is known to provide electrical centers with a bus bar for distributing the common voltage.

One important aspect in the utilization of bus bars is the proper retention and positioning thereof. Common retention systems make use of snap hooks for keeping bus bars in place and for preventing their disassembly. Several such snap hooks are typically used for providing proper positioning of the bus bar. FIGS. 1 and 2 show two prior art snap hook designs: One design with a flat surface (FIG. 1) and one with an angled surface (FIG. 2).

In general, the flat surface snap hook design of FIG. 1 features a beam or arm 1 and a snap hook 10. The bus bar 2, shown in lateral cross section, is in blocking contact with the flat surface 12 of the snap hook 10, thereby being hindered from removal along a lateral direction of the bus bar (i.e. along an upward direction in FIG. 1). By providing such snap hooks around the bus bar 2, a firm grip of the bus bar can be achieved. However, this flat surface snap hook design has the disadvantage that the bus bar 2 can easily slip out of the retention system when the snap hook bends slightly into an undesired direction (i.e. to the right side in FIG. 1).

Thus, the angled surface snap hook design as illustrated in FIG. 2 was developed for taking this bending into account. It differs from the flat surface snap hook design of FIG. 1 in that the surface 22 of the hook 20 is not perpendicular to the longitudinal direction of the arm 10. This negatively angled version is designed such that when the hook bends slightly in an undesired direction (i.e. to the right side in FIG. 2), a releasing of the bus bar 2 is still inhibited. However, this angled surface snap hook design also has the disadvantage in that the bus bar 2 can be released when higher retention forces are applied. Furthermore, since the contact point between the bus bar 2 and the hook 20 is far from the beam or arm 1, it is less stiff compared to the flat surface snap hook design of FIG. 1, in particular due to the longer lever arm of the force (i.e. larger torque applied).

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with an embodiment of the invention, a retention system for fixing a bus bar is provided and in particular for a system for retaining a bus bar to an electrical center of a vehicle. It will be appreciated that the bus bar can be any common bus bar, and may be configured for receiving and transporting electric currents. Preferably the bus bar is of a plate-like structure, and can, for example, be a stamped plate that is formed of an electrically conductive material. Further, the electric center is not limited to any particular structure, and can refer to any electrical component of a vehicle. The electrical center may be a fuse relay box, for example.

The retention system includes an arm. The arm may have a longitudinal extent and can also be present in form of a beam or a bar. Additionally, there is a hook provided on the arm. The hook can generally be of any form, but includes a retention groove with an essentially U-shaped cross section. The hook and arm may be referred to a clip, which may be provided on the electric center. The total length of the clip may depend on the used materials and the size of the bus bar. For example, the clip may be 12 mm long.

Furthermore, the retention system includes a bus bar which is arranged at least partially within the retention groove of the hook. In an embodiment of the invention, the bus bar is aligned parallel to the longitudinal dimension of the arm. An edge of the bus bar may by arranged in the retention groove. The thickness of the bus bar may for example be in the range of 0.6 to 1.2 millimeters (mm), and the thickness may preferably be 0.8 mm.

Accordingly, due to the at least partial arrangement of the bus bar within the retention groove, the bus bar is efficiently hindered from slipping away from the hook. Further, a larger retention force, which may act onto the bus bar driving it into the direction of the retention groove, can be absorbed without the bus bar slipping out of the hook and without damaging the hook. An accidental disassembling of the bus bar from the retention system is thus advantageously prevented. The bus bar may only be disassembled by bending the hook with a tool or by destroying the material, thus a strong retention of the bus bar is provided.

According to one embodiment of the invention, the retention system is configured to withstand retention forces of at least 60 N, more preferably of at least 70 N, even more preferably of at least 80 N, and most preferably of at least 82 N. The retention forces may thereby act on the bus bar for urging it farther into the retention groove. It may be appreciated that retention forces may act mainly in a lateral direction of the bus bar. Accordingly, a strong retention of the bus bar is provided.

The hook may be an integral part of the arm. Thus, only minimal internal tension arises within the arm/hook system when retention forces are applied. The arm and/or the hook may be made of a plastic material.

According to one embodiment of the invention, the essentially U-shaped cross section of the retention groove of the hook is defined by an outer leg, an inner leg and a base. Thus, the bus bar is arranged at least partially within a space spanned by the outer leg, the inner leg and the base. The retention groove may be shaped such that it can hinder a movement of the bus bar into at least three main directions.

The outer leg may be an integral part of the arm. Thus, the arm may essentially form the outer leg of the essentially U-shaped cross section of the retention groove of the hook. The stability of the retention system is thereby increased.

The base may include an essentially flat surface. It will be appreciated that an entirely flat surface is most desired. However, due to variations in manufacturing processes, such completely flat surfaces may not be obtainable. The essentially flat surface may have a width of 0.2 to 10 mm, more preferably of 0.4 to 5 mm, even more preferred of 0.6 to 2 mm and most preferred of 1.0 to 1.4 mm. It will be appreciated that the width of the essentially flat surface is such that it can receive the bus bar, and in particular an edge of the bus bar.

According to one embodiment of the invention, the width of the essentially flat surface is at least large enough for receiving the bus bar having a defined thickness. Accordingly, if the thickness of the bus bar is 1 mm for example, then the width of the essentially flat surface may be 1.2 mm for example.

According to one embodiment of the invention, the essentially flat surface is perpendicular to a longitudinal direction of the arm and/or perpendicular to a lateral direction of the bus bar. Thus, forces acting onto the bus bar are efficiently transferred to the hook/arm system, and the contact point of the bus bar may be close to the arm, so that the stiffness of the retention system is increased. The edge or side of the bus bar may be planar and in planar contact with the essentially flat surface of the hook.

The bus bar may be in retention contact with the base of the essentially U-shaped cross section of the retention groove. The term retention contact thereby describes that the bus bar is in contact with the base, and that the contact facilitates the retention of the bus bar, such that the bus bar is properly held in place, especially when retention forces are applied onto the bus bar. Any lateral forces acting on the bus bar are efficiently transferred to the hook and the arm of the retention system, thereby increasing the retention of the bus bar.

The essentially U-shaped cross section of the retention groove may have a discontinuous corner or a rectangular corner formed between the base and the outer leg. Thus, a transition from the base to the outer leg is not smooth, but rather abrupt, step-like, discontinuous or rectangular. Thus, when retention forces are applied, slipping of the bus bar out of the retention groove is prevented, as the bus bar is captured in the discontinuous or rectangular corner.

The essentially U-shaped cross section of the retention groove may have a smooth or rounded corner formed between the base and the inner leg. Thus, when retention forces are applied, these forces are efficiently transferred from the bus bar via the hook to the arm, without inducing any cracks or flaws between the hook and the arm. Accordingly, the retention system is very durable and can withstand high retention forces.

The outer leg may have a height of 0.05 to 5 mm, preferably of 0.08 to 1 mm, more preferably of 0.1 to 0.5 mm, and most preferably of 0.15 to 0.25 mm. The height may be measured along the lateral direction of the bus bar, or along the longitudinal direction of the arm. Preferably, the outer leg has a width of 0.1 to 5 mm, preferably of 0.15 to 2 mm, more preferably of 0.2 to 1 mm and most preferably of 0.2 to 0.5 mm. The width of the outer leg may be at least 0.25 mm. This width may be measured perpendicular to the height of the outer leg, and may be measured along a surface normal direction of the bus bar.

According to one embodiment of the invention, the retention groove is configured to be in blocking contact with the bus bar when the arm is flexed, so as to hinder additional flexing of the arm. The bus bar may be in blocking contact with the outer leg of the essentially U-shaped cross section of the retention groove. An accidental disassembling of the bus bar is thus prevented.

The retention groove may be produced by an undercut process. For example, a hook with an angled surface as known in the art with angle of 5 to 8 degrees may be provided. The angled surface may then be undercut, such that a tip or protrusion, i.e. the outer leg, is formed. The height of the tip is then defined by the angle and total length of the initial angled surface.

It will be appreciated that the retention system may include more than one clip for positioning the bus bar. Furthermore, the present invention relates to a clip for retaining a bus bar, in particular for retaining a bus bar in an electrical center. The clip may include an arm and hook as detailed above. The present invention also relates to an electrical center, in particular of a vehicle, which includes a bus bar and at least one clip for retaining the bus bar. The clip may include an arm and hook as detailed above.

### BRIEF DESCRIPTION OF THE SEVERAL VIEWS OF THE DRAWING

The present invention will now be described, by way of example with reference to the accompanying drawings, in which:

FIGS. 1 and 2 illustrate side views of prior art bus bar retention systems;

FIG. 3 illustrates a side view of a bus bar retention system according to one embodiment of the present invention;

FIG. 4 illustrates a side view of the retention system of FIG. 3 in another configuration; and

FIG. 5 is a chart illustrating results of a finite element analysis study comparing the prior art retention systems of FIGS. 1 and 2 with the retention system of FIG. 3.

### DETAILED DESCRIPTION OF THE INVENTION

Although the disclosure hereof is detailed and exact to enable those skilled in the art to practice the invention, the physical embodiments herein disclosed merely exemplify the invention which may be embodied in other specific structures. While a preferred embodiment has been described, the details may be changed without departing from the invention. A description of example embodiments of the invention follows.

It is an object of the present invention to provide a retention system which overcomes the above outlined disadvantages at least partially. It is in particular an object of the present invention to provide a retention system which can withstand high retention forces.

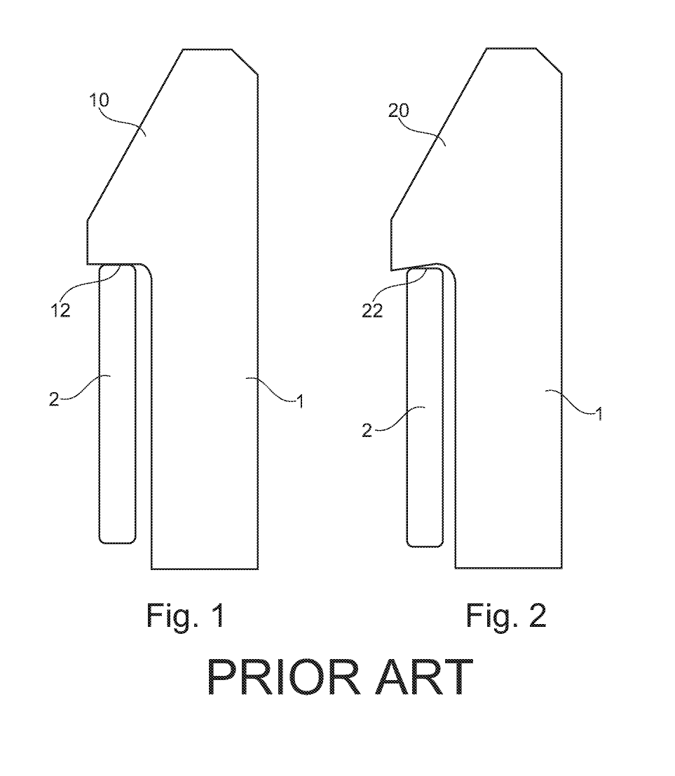

FIGS. 1 and 2 show prior art retention systems, designed with a flat surface 11 and negatively angled surface 21, respectively, as outlined above.

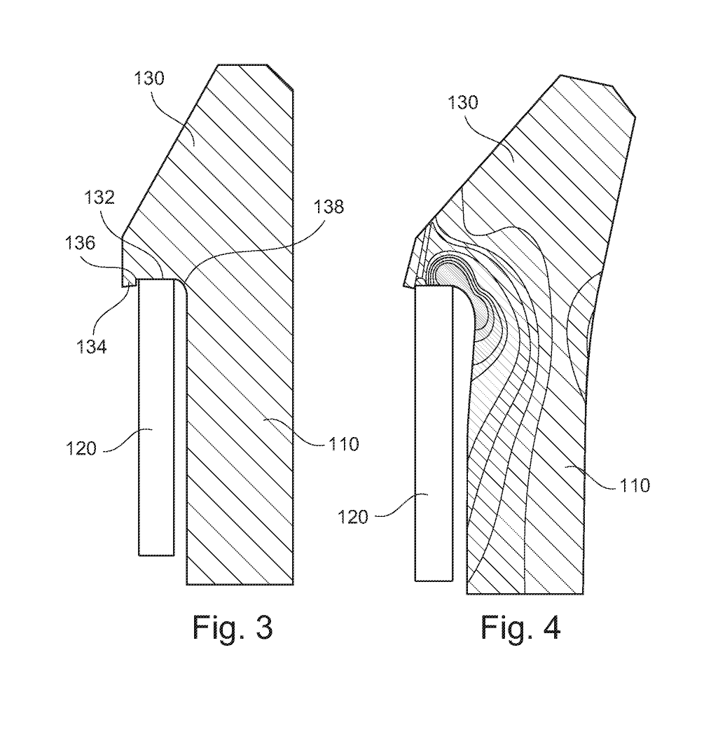

FIG. 3 illustrates a non-limiting example of a retention system according to one embodiment of the present invention. The retention system includes an arm 110 with a hook 130 provided thereon. The hook 130 defines a base 132 having a flat surface, which is in blocking contact with a bus bar 120. The base 132 is perpendicular to a longitudinal direction of the arm 110, and also perpendicular to the bus bar 120. The edge of the bus bar 120 is planar and in planar contact with the base 132 of the hook 130. The width of the base 132 is slightly larger than the thickness of the bus bar 120. Therefore, the contact point between the bus bar 120 and hook 130 is close to the arm 110, so that the clip features high stiffness.

Additionally, an outer leg or protrusion 134 is provided, and the flat surface 132 is located between the protrusion 134 and the arm 110. Thus, the protrusion 134, the flat surface 132 and the arm 110 form an essentially U-shaped cross section, in which the bus bar 120 is at least partially placed. The arm 110 forms the inner leg of the U-shaped groove, the protrusion 134 forms the outer leg and the flat surface 132 forms the base. The surface of the protrusion 134 is angled, since the illustrated embodiment was prepared from an negative angled surface as shown in FIG. 2. The negative angle surface was undercut, whereby the protrusion 134 and flat surface 132 were formed.

The transition 136 between the flat surface 132 and the protrusion 124 is step-like, i.e. a corner 136 is formed. Accordingly, when retention forces act on the bus bar 120, the edge of the bus bar is trapped in this corner 136. Additionally, the transition 138 between the flat surface 132 and the arm 110 is smooth, i.e. rounded. Thus, the system is very resilient.

FIG. 4 exemplarily presents the behavior of the retention system of FIG. 3 when retention forces are applied. The retention forces may be applied onto the bus bar 120 urging it against the flat surface 132 of the hook 130 (i.e. upwards in FIG. 4). As can clearly be seen, the bus bar 120 is hindered from slipping out of the hook 130, as the edge of the bus bar 120 is retained in the corner 136. Even under high retention forces, the forces are efficiently absorbed by the hook 130 and arm 110, whereby in particular the rounded transition 138 is able to withstand high strains without breaking.

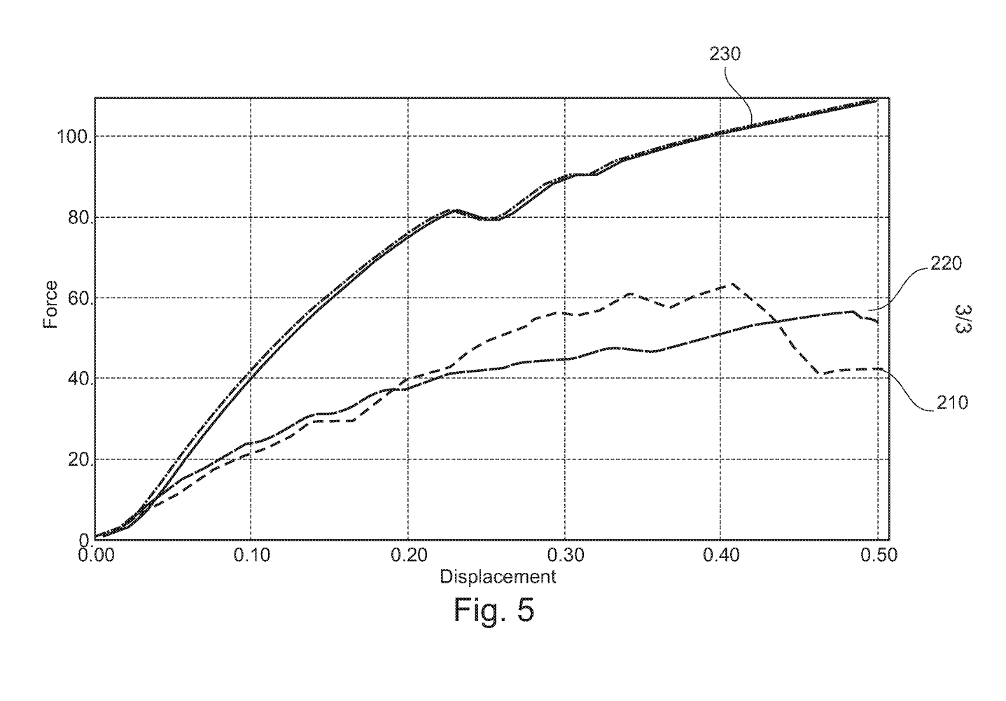

FIG. 5 illustrates results of a finite element analysis study, which was carried out for both prior art designs of FIGS. 1 and 2 as well as for the inventive design of FIG. 3. The illustrated diagram of FIG. 5 presents the retention force on the ordinate vs. the displacement of the bus bar on the abscissa. The results for the flat surface prior art hook design of FIG. 1 is labelled 210, while the results of the angled surface prior art hook design of FIG. 2 is labelled 220. The result of the design according to the embodiment of the present invention as described with reference to FIG. 3 is labelled 230.

It is clearly recognizable from the presented chart of FIG. 5 that the inventive design shown in FIG. 3 can withstand higher retention forces than the prior art designs shown in FIGS. 1 and 2. The flat and angled surface designs disengage at forces of around 55 N and 60 N, respectively. In comparison, the inventive retention system could well withstand forces of 82 N, which is an improvement of 49% and 36%, respectively, over the prior art designs of FIGS. 1 and 2.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. An electrical center configured for use in a vehicle, comprising:
a bus bar; and
a retention system including an arm and a hook provided on said arm, wherein said hook defines a retention groove with an essentially U-shaped cross section and wherein said bus bar is arranged at least partially within said retention groove.

2. The electrical center according to claim 1, wherein the hook is an integral part of the arm.

3. The electrical center according to claim 1, wherein the arm is formed of a plastic material.

4. The electrical center according to claim 1, wherein the hook is formed of a plastic material.

5. The electrical center according to claim 1, wherein the essentially U-shaped cross section of the retention groove of the hook is defined by an outer leg, an inner leg and a base.

6. The electrical center according to claim 5, wherein the outer leg is an integral part of the arm and is attached to a structure of the vehicle.

7. The electrical center according to claim 6, wherein the base defines an essentially flat surface.

8. The electrical center according to claim 7, wherein the essentially flat surface has a width of 0.2 to 10 mm.

9. The electrical center according to claim 8, wherein the essentially flat surface is perpendicular to a longitudinal direction of the arm.

10. The electrical center according to claim 8, wherein the essentially flat surface is perpendicular to a lateral direction of the bus bar.

11. The electrical center according to claim 8, wherein the bus bar is in retention contact with the base.

12. The electrical center according to claim 11, wherein the essentially U-shaped cross section of the retention groove has a discontinuous corner formed between the base and the outer leg.

13. The electrical center according to claim 11, wherein the essentially U-shaped cross section of the retention groove has a rectangular corner formed between the base and the outer leg.

14. The electrical center according to claim 11, wherein the essentially U-shaped cross section of the retention groove has a smooth corner formed between the base and the inner leg.

15. The electrical center according to claim 14, wherein the essentially U-shaped cross section of the retention groove has a rounded corner formed between the base and the inner leg.

16. The electrical center according to claim 14, wherein the outer leg has a height of 0.05 to 2 mm.

17. The electrical center according to claim 16, wherein the outer leg has a width of 0.1 to 5 mm.

18. The electrical center according to claim 17, wherein the retention groove is configured to be in blocking contact with the bus bar when the arm is flexed.

19. The electrical center according to claim 18, wherein the retention system is configured to withstand retention forces of at least 60 N.
